(19) United States
(12) Patent Application Publication
(10) Pub. No.: US 2021/0329508 A1
(43) Pub. Date: Oct. 21, 2021

(54) MANAGING FIFTH GENERATION (5G) NEW RADIO (NR) ANTENNA-SWITCHING CONCURRENCY

(71) Applicant: QUALCOMM Incorporated, San Diego, CA (US)

(72) Inventors: Thawatt Gopal, San Diego, CA (US); Brian Clarke Banister, San Diego, CA (US); Brian George, San Diego, CA (US); Vishal Mahajan, Dublin, CA (US)

(21) Appl. No.: 17/199,322

(22) Filed: Mar. 11, 2021

Related U.S. Application Data
(60) Provisional application No. 63/005,767, filed on Apr. 6, 2020.

(51) Int. Cl. H04W 36/00; H04B 7/06; H04W 48/16; H04W 72/10

(52) U.S. Cl. CPC H04W 36/0069; H04W 72/10; H04W 48/16; H04B 7/0602

(57) ABSTRACT

A method of wireless communication at a user equipment (UE) is presented. The UE may include one or more antennas which are shared between a first network connection and a second network connection in a dual connectivity mode. The method includes reporting a first sounding reference signal (SRS) antenna-switching capability to a base station. The method also includes transmitting an SRS to the base station via a second SRS antenna-switching capability when the first network connection has priority over the second network connection, where the second SRS antenna-switching capability is reduced with respect to the first SRS antenna-switching capability.

### CROSS REFERENCE

The present Application for Patent claims the benefit of U.S. Provisional Patent Application No. 63/005,767 by GOPAL et al., entitled “MANAGING FIFTH GENERATION (5G) NEW RADIO (NR) ANTENNA-SWITCHING CONCURRENCY,” filed Apr. 6, 2020, assigned to the assignee hereof, and expressly incorporated by reference herein.

### FIELD OF THE DISCLOSURE

Aspects of the present disclosure generally relate to wireless communications, and more particularly to techniques and apparatuses for managing fifth generation (5G) New Radio (NR) sounding reference signal (SRS) antenna-switching concurrency.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP).

A wireless communications network may include a number of base stations that can support communications for a number of user equipments (UEs). A UE may communicate with a base station via downlink and uplink communications. The downlink (or forward link) refers to the communications link from the base station to the UE, and the uplink (or reverse link) refers to the communications link from the UE to the base station. As will be described in more detail herein, a base station may be referred to as a Node B, a gNB, an access point (AP), a radio head, a transmit receive point (TRP), a New Radio (NR) base station, a 5G Node B, and/or the like.

The above multiple access technologies have been adopted in various telecommunications standards to provide a common protocol that enables different user equipment to communicate on a municipal, national, regional, and even global level. NR, which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or SC-FDM (e.g., also known as discrete Fourier transform spread OFDM (DFT-s-OFDM)) on the uplink, as well as supporting beamforming, multiple-input multiple-output (MIMO) antenna technology, and carrier aggregation.

### BRIEF DESCRIPTION OF THE DRAWINGS

So that features of the present disclosure can be understood in detail, a particular description, may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIGS. 3, 4A, 4B, 4C, 4D, and 4E are diagrams illustrating examples of NR SRS antenna-switching in accordance with aspects of the present disclosure.

FIG. 5 is a block diagram illustrating NR subframes and LTE subframes in accordance with aspects of the present disclosure.

FIGS. 6 and 7 show block diagrams of devices that support method to manage fifth generation (5G) New Radio (NR) sounding reference signal (SRS) antenna switching concurrency in evolved universal mobile telecommunications service (E-UMTS) terrestrial radio access network (E-UTRAN) new radio dual connectivity (ENDC) in accordance with aspects of the present disclosure.

FIG. 8 shows a block diagram of a communications manager that supports method to manage 5G NR SRS antenna switching concurrency in ENDC in accordance with aspects of the present disclosure.

FIG. 9 shows a diagram of a system including a device that supports method to manage 5G NR SRS antenna switching concurrency in ENDC in accordance with aspects of the present disclosure.

FIGS. 10 through 12 show flowcharts illustrating methods that support method to manage 5G NR SRS antenna switching concurrency in ENDC in accordance with aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

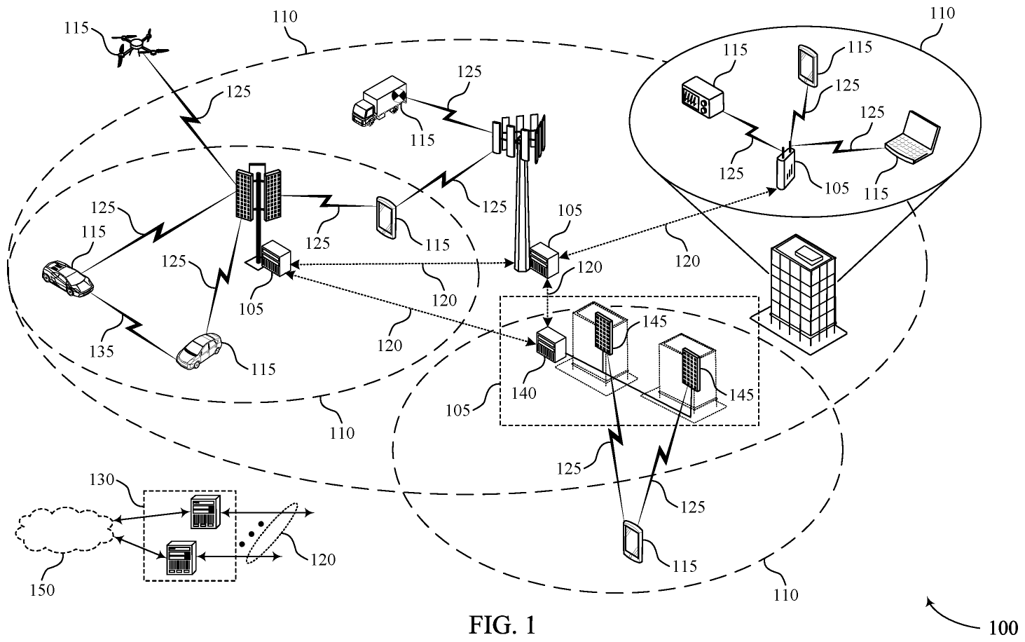

FIG. 1 illustrates an example of a wireless communications system 100 that supports method to manage fifth generation (5G) New Radio (NR) sounding reference signal (SRS) antenna switching concurrency in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some aspects, the UEs 115 and the base stations 105 of the wireless communications system 100 may support techniques for managing SRS antenna-switching concurrency. In particular, the UEs 115 of the wireless communications system 100 may be configured to determine whether SRSs are to be transmitted using a maximum SRS antenna-switching capability supported by the UE 115, or a reduced-SRS antenna-switching capability. In some cases, while operating in an evolved-UMTS (universal mobile telecommunications service) terrestrial radio access network (E-UTRAN) new radio dual connectivity (ENDC) mode of operation, the UEs 115 may be configured to determine whether SRSs should be transmitted using a maximum or reduced antenna-switching capability based on a relative priority of LTE communications and NR communications (e.g., based on relative priorities of a first (LTE) network connection and a second (NR) network connection). According to some implementations, the UE 115 may transmit SRSs with the maximum SRS antenna-switching capability when an NR network connection is prioritized over an LTE network connection. Conversely, according to some implementations, the UE 115 may transmit SRSs with a reduced SRS antenna-switching capability when an LTE network connection is prioritized over an NR network connections.

In some aspects, a UE 115 may be configured to determine a relative priority of LTE and NR network connections based on one or more characteristics or parameters associated with each of the respective network connections. Parameters associated with the network connections which may be used to determine a relative priority of the network connections may include, but are not limited to, antenna-switching diversity (ASDIV) configurations implemented by the UE 115, prioritization rules or policies, types of calls being performed over the respective network connections (e.g., high-priority calls), uplink and/or downlink activity over the respective network connections, uplink/downlink grant rates over the respective network connections, SNRs of the respective network connections, power headroom (PHR) metrics of the respective network connections, quantities of failed messages (e.g., RACH Msg 1, RACH Msg 3, scheduling requests) associated with the respective network connections, or any combination thereof.

Techniques described herein may enable improved SRS transmission in the context of a UE 115 operating in an ENDC mode of operation. In particular, techniques described herein may enable UEs 115 to determine a relative prioritization of LTE and NR network connections, which may be used to determine an SRS antenna-switching capability at which SRSs should be transmitted. By tailoring the SRS antenna-switching capability based on a relative priority of network connections, techniques described herein may improve the efficiency of SRS transmission while reducing or eliminating interruptions to LTE communications which are attributable to SRS transmission.

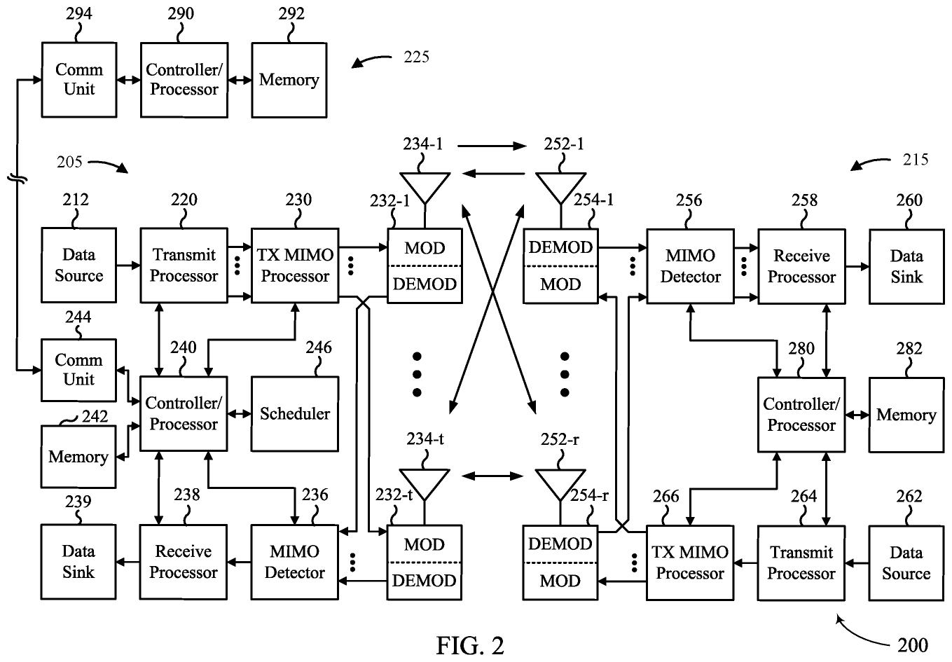

FIG. 2 shows a block diagram of a design 200 of the base station 205 and UE 215, which may be one of the base stations and one of the UEs in FIG. 1. The base station 205 may be equipped with T antennas 234-1 through 234-t, and UE 215 may be equipped with R antennas 252-1 through 252-r, where in general T≥1 and R≥1.

At the base station 205, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232-1 through 232-t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232-1 through 232-t may be transmitted via T antennas 234-1 through 234-t, respectively. According to various aspects described in more detail below, the synchronization signals can be generated with location encoding to convey additional information.

At the UE 215, antennas 252-1 through 252-r may receive the downlink signals from the base station 205 and/or other base stations and may provide received signals to demodulators (DEMODs) 254-1 through 254-r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254-1 through 254-r, perform MIMO detection on the received symbols if applicable, and provide detected symbols. A receive processor 258 may process (e.g., demodulate and decode) the detected symbols, provide decoded data for the UE 215 to a data sink 260, and provide decoded control information and system information to a controller/processor 280. A channel processor may determine reference signal received power (RSRP), received signal strength indicator (RSSI), reference signal received quality (RSRQ), CQI, and/or the like. In some aspects, one or more components of the UE 215 may be included in a housing.

On the uplink, at the UE 215, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254-1 through 254-r (e.g., for DFT-s-OFDM, CP-OFDM, and/or the like), and transmitted to the base station 205. At the base station 205, the uplink signals from the UE 215 and other UEs may be received by the antennas 234, processed by the demodulators 254, detected by a MIMO detector 236 if applicable, and further processed by a receive processor 238 to obtain decoded data and control information sent by the UE 215. The receive processor 238 may provide the decoded data to a data sink 239 and the decoded control information to a controller/processor 240. The base station 205 may include communications unit 244 and communicate to the network controller 225 via the communications unit 244. The network controller 225 may include a communications unit 294, a controller/processor 290, and a memory 292.

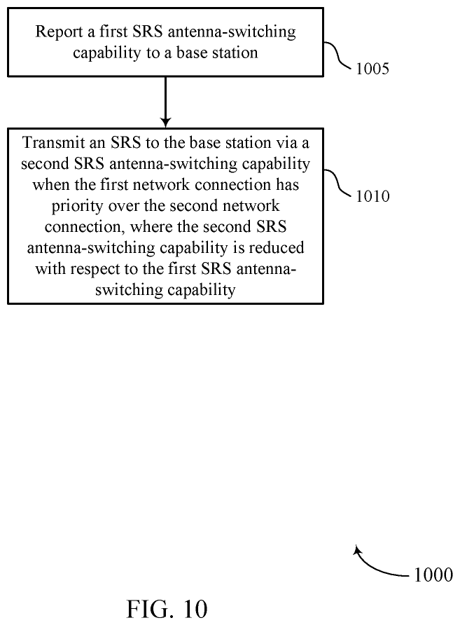

The controller/processor 240 of the base station 205, the controller/processor 280 of the UE 215, and/or any other component(s) of FIG. 2 may perform one or more techniques associated with machine learning for non-linearities, as described in more detail elsewhere. For example, the controller/processor 240 of the base station 205, the controller/processor 280 of the UE 215, and/or any other component(s) of FIG. 2 may perform or direct operations of, for example, the processes of FIGS. 10 to 12 and/or other processes as described. Memories 242 and 282 may store data and program codes for the base station 205 and UE 215, respectively. A scheduler 246 may schedule UEs for data transmission on the downlink and/or uplink.

In some aspects, the UE 215 may include means for advertising a maximum SRS antenna-switching capability to a base station. The UE 215 may also include means for transmitting an SRS to the base station via a reduced SRS antenna-switching capability or the maximum SRS antenna-switching capability. Such means may include one or more components of the UE 215 described in connection with FIG. 2.

As indicated above, FIG. 2 is provided merely as an example. Other examples may differ from what is described with regard to FIG. 2.

In some aspects, 5G NR SRS antenna-switching is specified by the 3GPP standard specifications and deployed by certain operators for time division duplex (TDD) bands. In TDD, due to downlink and uplink being on the same frequency channel, there is uplink/downlink channel reciprocity. A UE may have multiple receive antennas. The SRS antenna-switching allows a UE to select one or more receive antennas to transmit the SRS. An SRS is transmitted on an uplink from a UE to a base station (e.g., eNB/gNB). The SRS may improve downlink precoding for downlink MIMO enhancements.

An evolved-UMTS (universal mobile telecommunications service) terrestrial radio access network (E-UTRAN) new radio dual connectivity (ENDC) operating mode is one of the multi-radio access technology (RAT) dual connectivity (MR-DC) modes defined in the 3GPP standard. In the ENDC mode (e.g., dual connectivity mode), LTE is the primary cell (PCell) (e.g., master cell group (MCG)) and NR is the primary secondary cell (PSCell) (e.g., secondary cell group (SCG)). LTE and NR may have multiple carriers, therefore, each of LTE and NR may be different cell groups.

Various configurations may be specified for the ENDC mode. For example, in an NR system, such as an NR sub-6 GHz (NRsub6) system, NR SRS antenna-switching may be performed across different UE antennas to transmit an SRS on the uplink. Different NR SRS antenna-switching configurations may be specified. For example, the NR SRS antenna-switching may have a one-transmit-four-receive (1T4R) configuration (e.g., one transmit antenna selected from four receive antennas), or a one-transmit-two-receive configuration (1T2R) (e.g., one transmit antenna selected from two receive antennas). An NR sub-6 GHz system with uplink-MIMO may have a two-transmit-four-receive (2T4R) configuration for SRS antenna-switching. An LTE system may have a 1T4R or 1T2R configuration. In the ENDC mode, a radio frequency (RF) front-end may share four, five, or six antennas between LTE and NR. Antenna cross-switches may be shared between LTE and NR to transmit the SRS.

A dual connectivity LTE+NR system may be configured as an FDD+TDD system, a TDD+TDD system (e.g., synchronous and asynchronous network topologies), an FDD+FDD system, or a TDD+FDD system. SRS antenna-switching may be performed in an LTE FDD and NR (FDD+TDD) system. In this example, for NR, the UE may perform carrier-based SRS antenna switching where the UE performs downlink/uplink on FDD PSCell, and performs downlink only on the (NR) TDD SCell. Still, the UE may pause the FDD PSCell downlink/uplink to switch to the TDD SCell to transmit SRS symbols on the TDD carrier to assist the TDD's downlink MIMO pre-coding using the SRS transmitted on the uplink. The FDD PSCell downlink/uplink may be paused via NR SRS antenna-switching.

In an LTE and NR uplink-MIMO configuration, NR uplink-MIMO is 2×2 (e.g., spatial multiplexing via two uplink antennas) and downlink-MIMO is 4×4. For example, the NR's uplink/downlink MIMO SRS antenna-switching capability may be 2T4R (e.g., LTE 1T4R and NR 2T4R with 2T4R SRS on NR). For an LTE carrier aggregation (CA) and NR CA ENDC configuration, LTE1 may be a PCell (1T4R), LTE2 may be an SCell (1T4R), NR1 may be a PSCell (2T4R SRS), and NR2 may be an SCell (1T4R SRS). That is, various antenna configurations may be used in different scenarios (e.g., MIMO, CA, etc.).

The SRS may be configured for periodic transmission (e.g., semi-static transmission). The periodic transmission may be configured via RRC signaling. A periodicity for an SRS configuration may include: 1, 2, 4, 5, 8, 10, 16, 20, 32, 40, 64, 80, 160, 320, 640, 1280, or 2560 slots. Alternatively, the SRS may be configured for aperiodic transmission (e.g., dynamic transmission) via a grant (e.g., DCI Format 1_1 and DCI Format 0_1). Still further, the SRS may be semi-persistently activated/deactivated via a MAC control element (MAC-CE).

For each ENDC band combination, the UE may be configured for SRS antenna-switching via a supportedSRS-TxPortSwitch field in the 3GPP standard. The supportedSRS-TxPortSwitch field specifies whether the UE is configured for antenna-switching and the type of switching supported. For example, the supportedSRS-TxPortSwitch field may be enumerated with {t1r2, t1r4, t2r4, t1r4-t2r4, t1r1, t2r2, t4r4, notSupported}, as specified in 3GPP TS 38.214, V15.5.0, Section 6.2.1.2.

The txSwitchImpactToRx field may indicate bands in the ENDC band combination that may have a transmission impacted by the SRS antenna-switching. The txSwitchImpactToRx field may be set with one or more integer values to identify the band(s). Additionally, the txSwitchWithAnotherBand field may indicate bands in the ENDC that may have reception impacted by the SRS antenna-switching. The txSwitchWithAnotherBand field may be set with one or more integer values to identify the band(s).

In an ENDC mode, the LTE and NR uplink and downlink transmissions may be synchronous or asynchronous. The synchronous or asynchronous uplink and downlink transmissions may be set in the standard. Table 1 provides an example of the standard section for configuring synchronous or asynchronous uplink and downlink transmissions for LTE and NR. Table 1 is specified in 3GPP TS 38.306 and 38.331.

TABLE 1

| | | | | | |
|---|---|---|---|---|---|
| Simultaneous | Simultaneous | simultaneousRxTx- | MRDC- | For TDD-FDD and TDD- | Mandatory/Optional |
| reception and | reception and | InterBandENDC | Parameters | TDD band combinations | support depends on |
| transmission | transmission | | | for which simultaneous | band combination |
| for inter- | for inter-band | | | RxTx capability is agreed | and captured in TS |
| band EN-DC | EN-DC | | | to be supported, | 38.101-3. |
| (TDD-TDD | (TDD-TDD | | | corresponding capability | |
| or TDD- | or TDD- | | | indication must be set to | |
| FDD) | FDD) | | | “supported.” Band | |
| | | | | combinations for which | |
| | | | | simultaneous RxTx | |
| | | | | capability is mandatory | |
| | | | | EN-DC combinations | |
| | | | | (both FR1 LTE-FR1 NR | |
| | | | | and FR1 LTE-FR2 NR) | |
| | | | | are captured in TS 38.101-3 | |

Due to an RF front-end antenna and cross-switch sharing, NR SRS antenna-switching may impact LTE's transmit (Tx) and/or receive (Rx) operations. LTE transmissions may be impacted due to interruptions caused by the NR SRS antenna-switching. LTE transmit interruptions result in a loss of ENDC uplink transmissions at a UE. Accordingly, it is desirable to avoid LTE transmit interruption to prevent a loss of uplink transmissions.

In the ENDC mode, RRC/non-access stratum (NAS) control signaling can be supported via system resource block (SRB) 1 (SRB1), SRB2, or both, on the dedicated control channel (e.g., logical channel) between the UE and the base station. Additionally, in the ENDC mode, an SRB 3 (e.g., SRB3) may be configured to transfer NR RRC messages between the UE and the base station via the NR radio interface (see 3GPP TS 36.331 section 4.2.2). Still, SRB3 may not be supported on commercial networks. Hence, for a UE operating in the ENDC mode on a current commercial network, the UE may transmit control signals via SRB1/SRB2 on an LTE/MCG link to the base station. It is desirable to maintain the reliability of the control signal transmissions.

For a TDD synchronous LTE and NR dual connectivity configuration (e.g., TDD+TDD), LTE transmission may be blanked or interrupted if NR SRS antenna-switching causes the NR transmission to switch to (e.g., conflict with) an LTE transmit/receive (Tx/Rx) antenna. In TDD+TDD mode, a UE may not support simultaneous LTE transmission/reception (Tx/Rx) concurrent with an NR transmission. In this example, it is implied that the LTE reception is concurrent with the NR reception because the LTE reception cannot be concurrent with the NR transmission. The concurrent LTE reception and NR reception is indicated via UE capability signaling referenced in the UE's RRC signaling to the base station (e.g., eNB, gNB).

For an FDD+TDD LTE and NR dual connectivity configuration, both LTE transmission and reception may be blanked or interrupted if the NR SRS antenna-switching causes the NR transmission to switch to the LTE transmit/receive (Tx/Rx) antenna. In LTE FDD, LTE transmission and reception may operate in a full duplex mode.

In some aspects, a UE may be configured to prioritize one network connection over another based on one or more characteristics associated with the UE, characteristics associated with the network, characteristics associated with communications performed over the respective network connections, or any combination thereof. For example, when a high-priority call (e.g., critical traffic) such as an emergency 911 call, a voice call, or video telephony call is being performed over the first network connection (e.g., LTE network connection), the first network connection may be prioritized over the second network connection (e.g., NR network connection) so as to reduce or prevent interruptions to the high-priority call. Similarly, if a higher priority call is being performed over a first NR network connection, the first NR network connection may be prioritized over a second NR network connection in order to reduce or prevent interruptions to the high-priority call.

In some aspects, LTE ACK/NACK bundling for LTE TDD HARQ feedback may generate a single ACK/NACK report based on the ACK/NACKs of the assigned subframes within the set of associated subframes. As such, interruptions to an LTE bundled ACK/NACK report transmission may impact LTE's performance and/or reliability.

In some cases, the UE selects a Tx antenna via a Tx ASDIV function. In particular, the Tx ASDIV may be configured to select the best Tx antenna. For example, when a user holds a UE, the Tx ASDIV function may select a Tx antenna that is not blocked by the user's hand. In some aspects, in the dual connectivity mode (e.g., ENDC mode), if LTE and NR share an antenna and antenna cross-switches, LTE may be prioritized to select a Tx antenna via the UE's Tx ASDIV function. Different LTE ASDIV configurations may impact the LTE Tx/Rx interruption due to NR SRS antenna-switching.

On the other hand, degrading a number of antennas used for NR SRS-switching may impact NR downlink performance due to an inability to sound on all possible NR Rx antenna ports. For example, if the UE's NR SRS capability is 1T4R, degrading to 1T2R may reduce the NR downlink throughput because the base station may only receive sounding information on two antennas instead of four. That is, although the UE is capable of transmitting the SRS from one of four antennas, the UE may only transmit the SRS on one of two antennas. Signaling a downgrade of the UE's SRS UE-capability specifies the UE to declare a radio link failure and perform an attach/detach procedure to provide updated radio capabilities. As such, signaling the downgrade may be time consuming and may reduce performance.

Aspects of the present disclosure are directed to reporting (e.g., advertising) a maximum NR SRS antenna-switching capability while dynamically adjusting the NR SRS antenna-switching capability. In some aspects, the maximum NR SRS antenna-switching capability is an antenna-switching configuration (mTnR with m, n indicating the number of transmit and receive antennas) of a UE for SRS antenna-switching. In some aspects, the maximum NR SRS antenna-switching capability may refer to the antenna-switching configuration which the UE is configured with (at the time of performing the NR SRS antenna-switching). In other aspects, the maximum NR SRS antenna-switching capability may refer to the maximum antenna-switching configuration which the UE may be configured with. In one configuration, NR SRS antenna-switching is performed at a reduced capability if the NR SRS antenna-switching interrupts an LTE Tx based on a prioritization policy (e.g., pre-defined prioritization policy). That is, the NR SRS antenna-switching capability may be reduced if the NR SRS antenna-switching causes certain LTE Tx interruptions (e.g., temporary loss of LTE Tx signal). In some cases, the base station may not be informed of the reduced capability. Aspects of the present disclosure are discussed with regard to an RF front-end design involving an RF front-end or antennas shared between LTE and NR in a dual connectivity mode (e.g., ENDC).

Additional aspects of the present disclosure are directed to prioritizing the LTE Tx antenna or prioritizing the NR SRS antenna-switching capability based on prioritization criteria. Prioritizing the LTE Tx antenna may allow the UE to select a preferred Tx antenna at the cost of reducing the NR SRS antenna-switching capability. For example, if LTE Tx is prioritized, the LTE Tx antenna is not interrupted due to NR SRS antenna-switching. In this example, the maximum NR SRS antenna-switching capability may be 1T4R. An NR SRS antenna may be masked to prevent a conflict with the LTE Tx antenna, thereby avoiding LTE Tx interruption/blanking. Masking one or more NR SRS antenna may reduce the effective NR SRS antenna-switching to 1T3R, 1T2R, or 1T1R.

As discussed, the supportedSRS-TxPortSwitch field may be enumerated with {t1r2, t1r4, t2r4, t1r4-t2r4, t1r1, t2r2, t4r4, notSupported}. In some cases, t1r3 is not enumerated in the supportedSRS-TxPortSwitch field. Still, from the UE's point of view, if the UE signals T1R4 to network via RRC signaling procedure, the UE may use a less capable NR SRS antenna-switching configuration such as T1R3, T1R2, or T1R1. The configuration may be dependent on the Tx-antenna ASDIV antenna switch function for the LTE Tx antenna. That is, when reducing a capability of the NR SRS antenna-switching configuration, the UE may select a configuration (e.g., T1R3) that is not enumerated in the supportedSRS-TxPortSwitch field. Additionally, the UE may select a reduced configuration without informing the base station (e.g., the UE may autonomously select the reduced configuration).

Prioritizing the NR SRS antenna-switching capability allows for the NR SRS antenna-switching to be performed at a maximum capability. For example, for a 1T4R NR SRS antenna-switching capability, the NR SRS may switch across four antennas even if the LTE Tx is blanked due to shared cross-switch/antennas.

In some aspects, the prioritization between LTE and NR may be determined semi-statically based on a call type. For example, LTE may be prioritized if the call type is a high-priority call type, such as an IP multimedia-system (IMS) call (e.g., voice call, video telephony call), emergency-call, E-911-type call, or other high-priority call types. In some aspects, the LTE Tx may not be interrupted when LTE is prioritized. Additionally, the NR SRS antenna-switching capability may be reduced to less than a maximum capability when LTE is prioritized. For example, a 1T4R capability may be reduced to 1T3R or 1T2R. This prioritization protects data and control signaling sent on the LTE uplink when such a call type is initiated. Otherwise, NR SRS antenna-switching may be prioritized to make use of a maximum capability. For example, if the NR SRS antenna-switching maximum capability is 1T4R, NR SRS may transmit the SRS from all four antennas.

Exemplary pseudo-code for prioritizing LTE based on a high-priority call type is as follows:

```
  IF LTE CALL_TYPE == {IMS, Emergency, E-911, VoLTE},
    Prioritize the LTE's uplink
    Set NR SRS antenna-switching to reduced
    capability (e.g., 1T4R -> 1T3R)
  ELSE
    Set NR SRS antenna-switching to maximum
    capability (e.g., 1T4R)
  END
where VoLTE denotes voice over LTE.
```

In one configuration, the UE dynamically performs NR SRS antenna-switching at a reduced capability based on LTE's ASDIV configuration and/or timing of LTE's Tx with respect to the timing of the NR SRS antenna-switching. If a conflict is detected between the LTE Tx antenna and the NR SRS Tx antenna, UE may sound (e.g., transmit) NR SRS on a non-conflicting antenna. That is, the NR SRS antenna-switching capability may be reduced to avoid a conflict. For example, the NR SRS antenna-switching capability may be dynamically reduced from 1T4R to 1T3R when the UE detects a conflict between a transmission from an NR target SRS antenna and a transmission from LTE's target antenna. The conflict may be determined from the RF antenna cross-switch and antenna sharing topology.

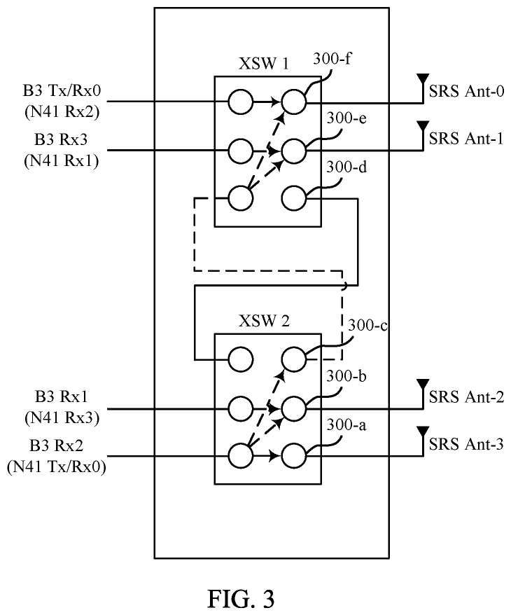

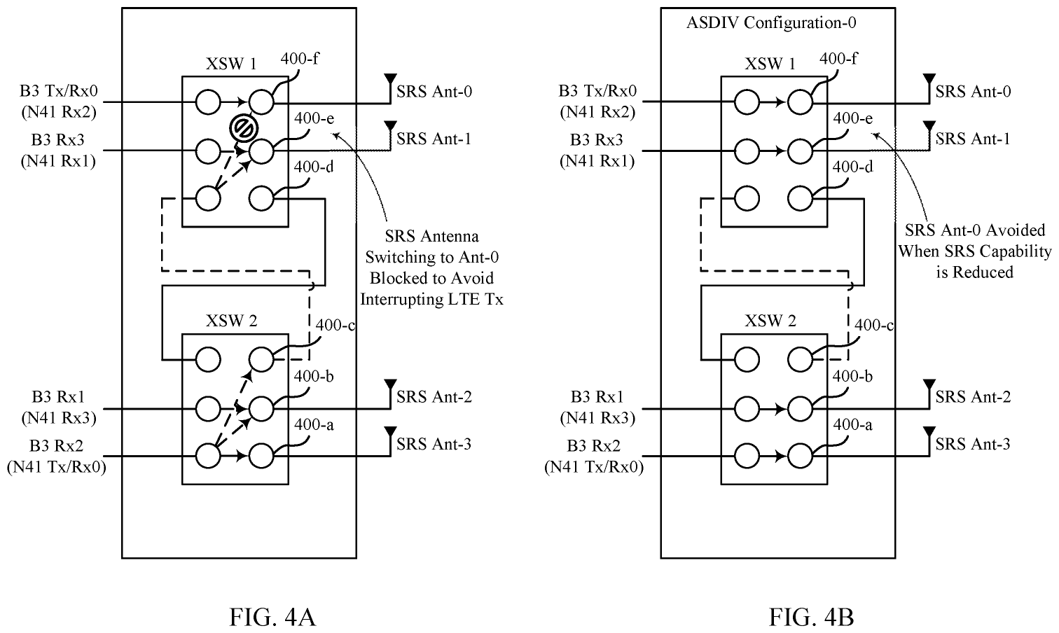

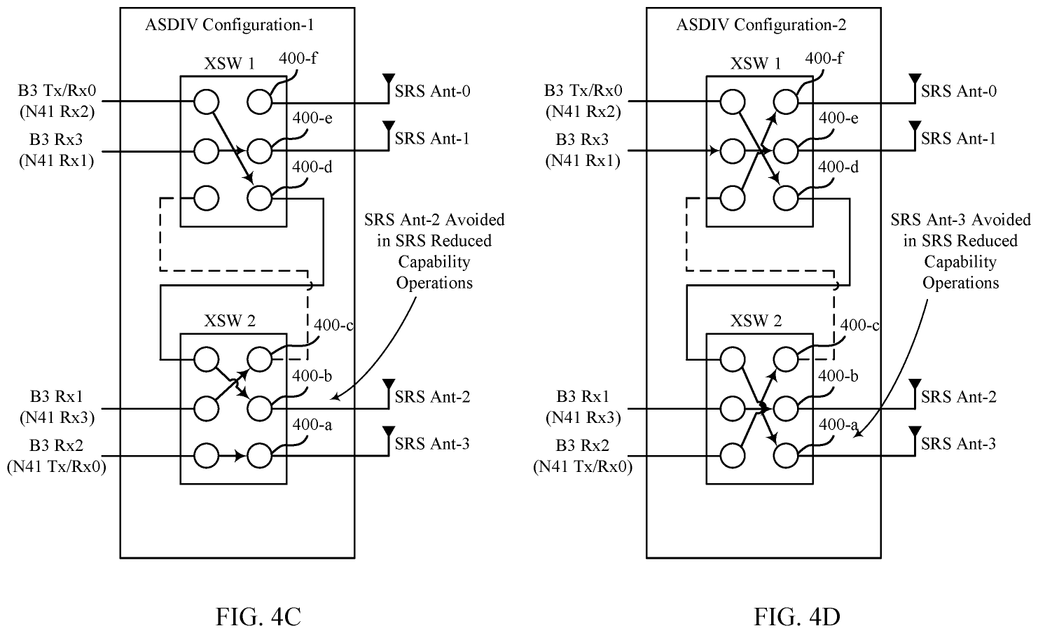

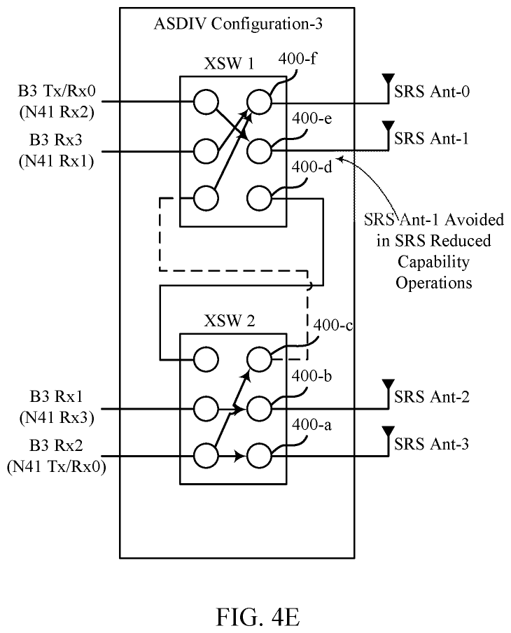

In one configuration, the NR SRS antenna-switching capability reduction may be performed in a semi-static manner based on LTE's ASDIV function (e.g., ASDIV configuration). As shown in FIGS. 3 and 4A-E, NR SRS antenna-switching is blocked for one or more antennas selected as an LTE Tx antenna by the ASDIV function (e.g., ASDIV configuration). In some aspects, the UE's NR L1/MAC may perform NR SRS antenna-switching at a reduced capability (e.g., 1TXR instead of 1T4R, where X<4). Additionally or alternatively, the NR SRS antenna-switching capability reduction may be dynamically performed based on LTE's Tx antenna selection (e.g., ASDIV configuration) and/or LTE's Tx subframe time-occasion (for LTE TDD).

As shown in FIG. 3, a UE may be configured with four antennas (e.g., Ant 0-Ant 3). Additionally, in the example of FIG. 3, LTE is operating on band 3 (B3) and NR is operating on band 41 (N41). As illustrated in FIG. 3, for ASDIV configuration zero, the LTE transmissions (B3 Tx) are specified for antenna zero (Ant 0). Additionally, LTE may receive on antennas zero to three (B3 Rx0-B3 Rx3).

Furthermore, for the example of FIG. 3, NR control information (e.g., PUCCH) is transmitted (N41 Tx) on antenna three. The SRS may be transmitted on a last set of symbols (e.g., last six symbols) of a slot. Based on a specified pattern, UE may transmit the SRS via any one of antennas zero to three. The NR SRS Tx antenna may be selected by switching one or more gates 300-a through 300-f of a cross switch (XSW) box. As shown in FIG. 3, the cross switch boxes (e.g., XSW 1 and XSW 2) are cascaded. For example, if the SRS is transmitted in a periodic manner, the SRS is transmitted from each antenna, one at a time at each transmit period.

In the current example, when the SRS is transmitted via antenna zero, the LTE Tx may be temporarily disconnected. That is, the LTE B3 Tx or Rx0 on antenna zero may be impacted. Additionally, by switching from a first gate 300-a to a third gate 300-c, LTE Rx2 may be impacted. Still, the LTE Tx via antenna zero is selected based on the ASDIV configuration. Therefore, the LTE Tx may be prioritized over the NR SRS Tx from antenna zero. As such, the NR SRS may be reduced to transmissions via only antennas one to three.

FIG. 4A illustrates an example of blocking the NR SRS Tx from antenna zero, while the ASDIV configuration specifies LTE Tx via antenna zero. In one configuration, the UE is aware of the ASDIV configuration prior to selecting antenna zero for the NR SRS transmission. Therefore, the UE does not transmit the NR SRS from antenna zero while antenna zero is specified for the LTE Tx.

FIG. 4B illustrates another example of blocking the NR SRS Tx from antenna zero, while the ASDIV configuration specifies LTE Tx via antenna zero. For a reduced capability, the NR SRS may only be transmitted from antennas one to three. For the maximum capability, the NR SRS may be transmitted from antennas zero to three.

FIG. 4C illustrates an example of blocking the NR SRS Tx from antenna two while the ASDIV configuration specifies LTE Tx via antenna two. For a reduced capability, the NR SRS may only be transmitted from antennas zero, one, and three. For the maximum capability, the NR SRS may be transmitted from antennas zero to three.

FIG. 4D illustrates an example of blocking the NR SRS Tx from antenna three, while the ASDIV configuration specifies LTE Tx via antenna three. For a reduced capability, the NR SRS may only be transmitted from antennas zero to two. For the maximum capability, the NR SRS may be transmitted from antennas zero to three.

FIG. 4E illustrates an example of blocking the NR SRS Tx from antenna one while the ASDIV configuration specifies LTE Tx via antenna one. For a reduced capability, the NR SRS may only be transmitted from antennas zero, two, and three. For the maximum capability, the NR SRS may be transmitted from antennas zero to three.

In another aspect, NR SRS antenna-switching capability reduction may be dynamically performed based on LTE's Tx antenna selection (e.g., ASDIV configuration) and/or an LTE's Tx activity time-occasion (for LTE FDD). The activity time-occasion may be based on a known Tx occasion. The Tx occasion may be determined from a periodic type of activity, such as voice over LTE (VoLTE), whereby pre-known LTE Tx subframes are used for LTE VoLTE transmission and timing information can be provided to the UE's NR SRS controller in the modem (e.g., a start/end time referenced to a common known timing source provided by the LTE controller to the NR L1 controller). In some aspects, the UE may prioritize the first or second network connection over the other based on timing conflicts between sets of transmit occasions associated with calls performed over the respective network connections. In particular, conflicts between calls with known transmit occasions may be used to prioritize one network connection over another. For example, the UE may prioritize the first network connection over the second network connection based on a timing conflict between a first set of transmit occasions associated with a first call performed over the first network connection and a second set of transmit occasions associated with a second call performed over the second network connection. The calls performed over the respective network connections may include any calls known in the art including, but not limited to, E-911 calls, IMS calls, VoIP calls, VoLTE calls, video telephony calls, and the like

As another example, the activity time-occasion may include a known LTE ON/OFF occasion, such as LTE connected mode discontinuous reception (CDRX)-ON/OFF periodicity. Such periodicity and timing information may be provided to the UE's NR SRS controller (e.g., LTE's CDRX ON/OFF duration and periodicity referenced to a common known timing source provided from LTE to an NR software module). In some aspects, the UE may be configured to prioritize one network connection over another based on timing conflicts between DRX procedures (e.g., CDRX procedures) associated with the respective network connections. For example, the UE may prioritize the first network connection over the second network connection based at least in part on a first DRX procedure associated with the first network connection and a second DRX procedure associated with the second network connection. In particular, the UE may prioritize the first network connection over the second network connection based at least in part on a timing conflict between a first ON-duration of the first DRX procedure and a second ON-duration of the second DRX procedure.

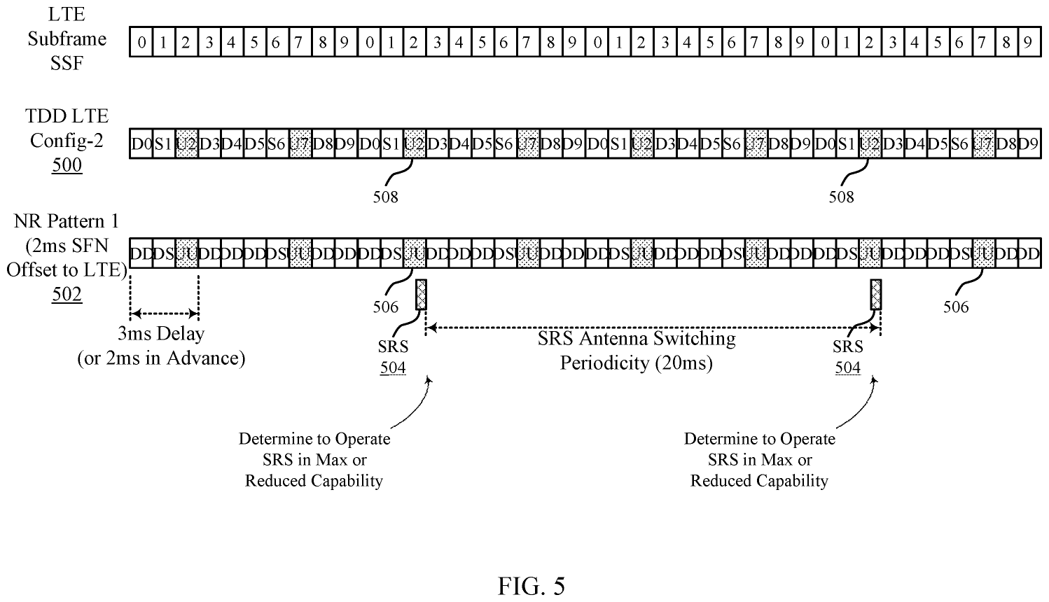

FIG. 5 illustrates an example of LTE TDD config-2 DL/UL configuration with NR pattern1. As shown in FIG. 5, a subframe pattern 500 for LTE config-2 includes six downlink subframes (e.g., D0, D3, D4, D5, D8, D9), two special subframes (e.g., S1, S6), and two uplink subframes (e.g., U2, U7). FIG. 5 also illustrates a subframe configuration for NR pattern 1 502. A 3 ms delay or a 2 ms subframe offset may synchronize the LTE TDD subframe pattern 500 and the NR subframe pattern 1 502, such that Tx/Rx is synchronized between LTE and NR.

In the example of FIG. 5, an NR SRS 504 is transmitted in an NR uplink subframe (SF) 506 that overlaps with an LTE uplink subframe 508. According to aspects of the present disclosure, the UE will determine whether to operate the NR SRS antenna-switching at a maximum capability or a reduced capability when the SRS Tx from the NR uplink SF 506 overlaps with an LTE TX from an uplink SF 508. In the example of FIG. 5, the NR SRS antenna-switching occurs with a 20 ms periodicity.

In aspects of the present disclosure, UE dynamically adjusts the NR SRS antenna-switching capability based on LTE's uplink activity. For example, if LTE's uplink activity is greater than an uplink activity threshold over a period of time, LTE may be prioritized and the NR SRS antenna-switching capability may be reduced to avoid LTE Tx blanking. In some aspects, LTE's uplink activity may be determined based on uplink subframe activity for physical uplink shared channel (PUSCH) or physical uplink control channel (PUCCH). For example, if one out of ten uplink subframes in a radio frame is associated with PUCCH/PUSCH, the uplink activity may be determined to be 10% (e.g., 10% uplink activity). The uplink activity may be observed for a period of time, such as 500 ms or 1 second. In some aspects, an average uplink activity may be determined and compared with an uplink activity threshold. For example, if the threshold is 20% and the observed LTE uplink activity is 30% (e.g., average uplink activity is greater than the uplink activity threshold), LTE uplink may be prioritized and NR SRS may be specified to operate at a reduced capability. In some cases, the uplink activity threshold may be differentiated for cases where LTE TDD ACK/NACK bundling is supported in the network and cases where LTE TDD ACK/NACK bundling is not supported. For example, a more conservative threshold may be specified when ACK/NACK bundling is supported (e.g., 10%) and a less conservative threshold may be specified when ACK/NACK bundling is not supported (e.g., 25%).

By specifying the uplink activity threshold, the UE may detect times with sufficient uplink LTE traffic, thereby warranting avoidance of LTE uplink interruption due to NR SRS antenna-switching.

Exemplary pseudo-code for prioritizing LTE based on the uplink activity threshold may be as follows:

```
IF LTE UL_Activity > Threshold
  Prioritize LTE's uplink
  Set NR SRS antenna-switching to reduced
  capability (e.g., 1T4R -> 1T3R)
ELSE
  Set NR SRS antenna-switching to max capability (e.g., 1T4R)
END
```

In one configuration, UE dynamically adjusts the NR SRS antenna-switching capability based on LTE's PDCCH grant rate. For example, if the LTE PDCCH downlink grant rate exceeds a downlink grant rate threshold (e.g., PDCCH downlink grant rate>downlink grant rate threshold), the NR SRS antenna-switching capability is reduced. Otherwise, NR SRS antenna-switching operates at maximum capability. Additionally, or alternatively, if the LTE PDCCH uplink grant rate exceeds an uplink grant rate threshold (e.g., PDCCH uplink grant rate>uplink grant rate threshold), the NR SRS antenna-switching capability is reduced. Otherwise, the NR SRS antenna-switching operates at maximum capability. The downlink grant rate threshold may be the same or different from the uplink grant rate threshold.

In one configuration, the NR SRS operates at a reduced capability when LTE traffic exceeds a threshold. The NR SRS operates at the reduced capability until LTE traffic is less than a threshold. This process accounts for certain network policies of diverting data traffic to the NR RAT if a device supports NR while reserving LTE network capacity for legacy devices that do not support the NR RAT.

Exemplary pseudo-code for prioritizing LTE based on LTE's PDCCH grant rate may be as follows:

```
IF LTE PDCCH_DL_GrantRate > Threshold1
  Prioritize LTE's uplink
  Set NR SRS antenna-switching to reduced capability
  (e.g., 1T4R -> 1T3R)
ELSE IF LTE PDCCH UL GrantRate > Threshold2
  Prioritize LTE's uplink
  Set NR SRS antenna-switching to reduced capability
  (e.g., 1T4R -> 1T3R)
ELSE
  Set NR SRS antenna-switching to max capability (e.g., 1T4R)
END
```

In one configuration, UE dynamically adjusts the NR SRS antenna-switching capability based on LTE's PDCCH grant rate and an SNR and/or an uplink PHR. For example, if the LTE PDCCH downlink grant rate exceeds a downlink grant rate threshold (e.g., PDCCH downlink grant rate>downlink grant rate threshold) and the LTE SNR is less than an SNR threshold (e.g., SNR<SNR threshold), the NR SRS antenna-switching capability may be reduced. Otherwise, NR SRS antenna-switching may operate at maximum capability. Additionally, or alternatively, if the LTE PDCCH uplink grant rate exceeds an uplink grant rate threshold (e.g., PDCCH uplink grant rate>uplink grant rate threshold) and the LTE PHR is less than a PHR threshold (e.g., PHR<PHR threshold), the NR SRS antenna-switching capability may be reduced. Otherwise, NR SRS antenna-switching may operate at maximum capability. The downlink grant rate threshold, uplink grant rate threshold, SNR threshold, and PHR threshold may be the same or different from each other.

As discussed, the NR SRS antenna-switching capability may be reduced if LTE's downlink grant rate is large (e.g., larger than a downlink grant rate threshold) and LTE's SNR is low (e.g., smaller than an SNR threshold). Additionally, the NR SRS antenna-switching capability may be reduced when the LTE uplink grant rate is large (e.g., greater than an uplink grant ate threshold) and LTE's PHR is low (e.g., smaller than a PHR threshold).

Exemplary pseudo-code for prioritizing LTE based on LTE's PDCCH grant rate and one of SNR or PHR may be as follows:

```
IF (LTE PDCCH_DL_GrantRate > Threshold1)
AND (LTE_SNR < Threshold3)
  Prioritize LTE's uplink
  Set NR SRS antenna-switching to reduced capability
  (e.g., 1T4R -> 1T3R)
ELSE IF (LTE PDCCH_UL_GrantRate > Threshold2) AND
(LTE_PHR < Threshold4)
  Prioritize LTE's uplink
  Set NR SRS antenna-switching to reduced capability
  (e.g., 1T4R -> 1T3R)
ELSE
  Set NR SRS antenna-switching to max capability (e.g., 1T4R)
END
```

In one configuration, UE dynamically adjusts the NR SRS antenna-switching capability based on LTE's count of random access channel (RACH) Msg-1 failures, RACH Msg-3 failures, and/or scheduling request (SR) failures. For example, the NR SRS antenna-switching capability is reduced if the RACH Msg-1 failures are greater than a first threshold, the RACH Msg-3 failures are greater than a second threshold, the SR failures are greater than a third threshold, or any combination thereof. Otherwise, NR SRS antenna-switching operates at maximum capability. The thresholds may be failure count values. The first, second, and third thresholds may be the same or different from each other.

High-priority messages, such as RACH messages and scheduling requests, specify a reliable uplink channel. Failure to transmit one or more of these messages may result in a radio link failure. For a dual connectivity mode (e.g., ENDC), the radio link failure results in both LTE and NR radio link failures. Therefore, it is desirable to reduce the NR SRS antenna-switching capability to provide a reliable uplink channel for high-priority messages.

Exemplary pseudo-code for prioritizing LTE based on RACH procedures and scheduling requests may be as follows:

```
IF (RACH Msg_1_fail_count > Threshold1) OR
(RACH Msg_3_fail_count > Threshold2) OR
(SR_fail_count > Threshold3)
  Prioritize LTE's uplink
  Set NR SRS antenna-switching to reduced capability
  (e.g., 1T4R -> 1T3R)
ELSE
  Set NR SRS antenna-switching to max capability (e.g., 1T4R)
END
```

As indicated above, FIGS. 3-5 are provided as examples. Other examples may differ from what is described with respect to FIGS. 3-5.

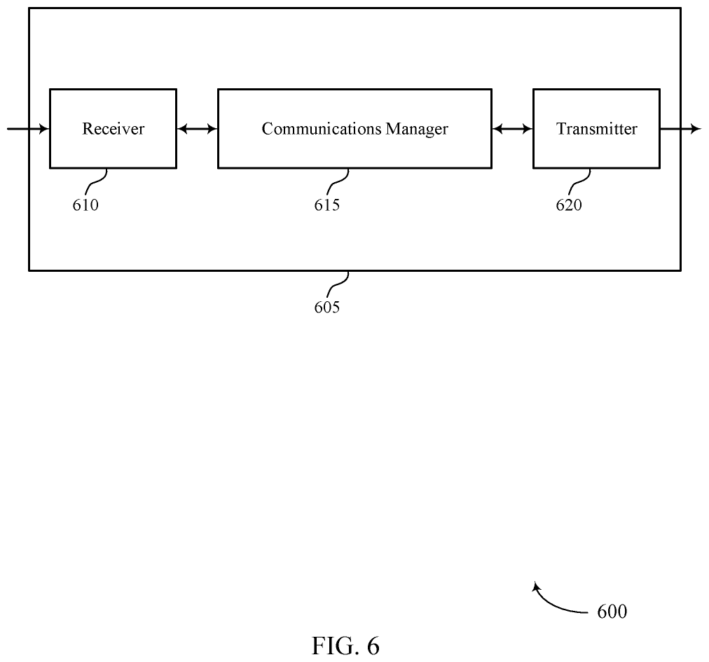

FIG. 6 shows a block diagram 600 of a device 605 that supports method to manage 5G NR SRS antenna switching concurrency in ENDC in accordance with aspects of the present disclosure. The device 605 may be an example of aspects of a UE 115 as described herein. The device 605 may include a receiver 610, a communications manager 615, and a transmitter 620. The device 605 may also include a processor. Each of these components may be in communication with one another (e.g., via one or more buses).

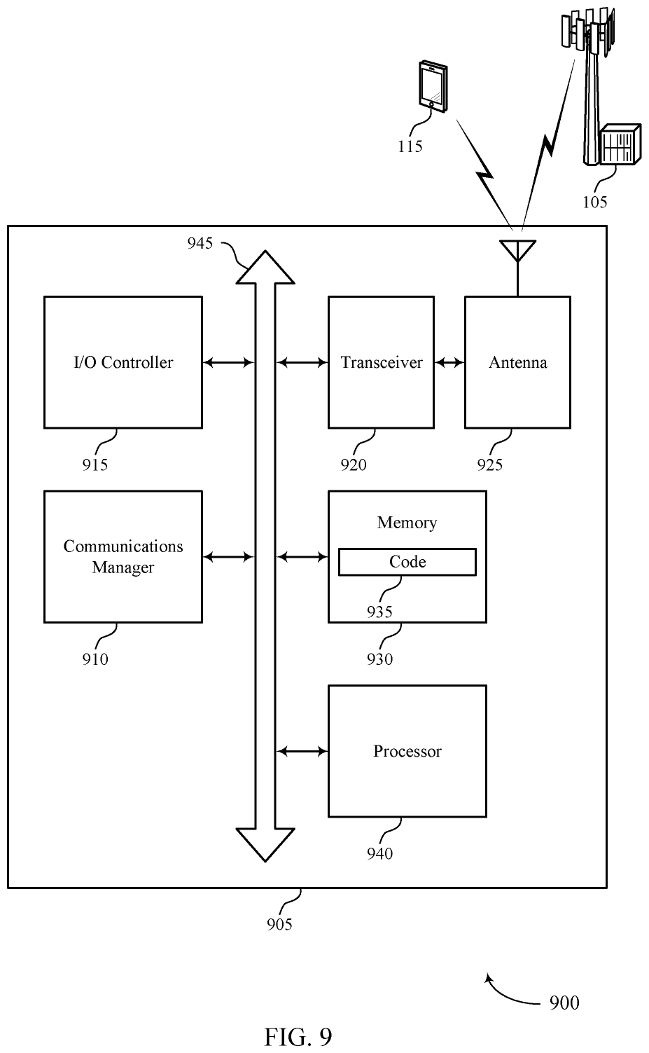

The receiver 610 may receive information such as packets, user data, or control information associated with various information channels (e.g., control channels, data channels, and information related to method to manage 5G NR SRS antenna switching concurrency in ENDC, etc.). Information may be passed on to other components of the device 605. The receiver 610 may be an example of aspects of the transceiver 920 described with reference to FIG. 9. The receiver 610 may utilize a single antenna or a set of antennas.

The communications manager 615 may report a maximum SRS antenna-switching capability to a base station and transmit an SRS to the base station via a reduced SRS antenna-switching capability. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

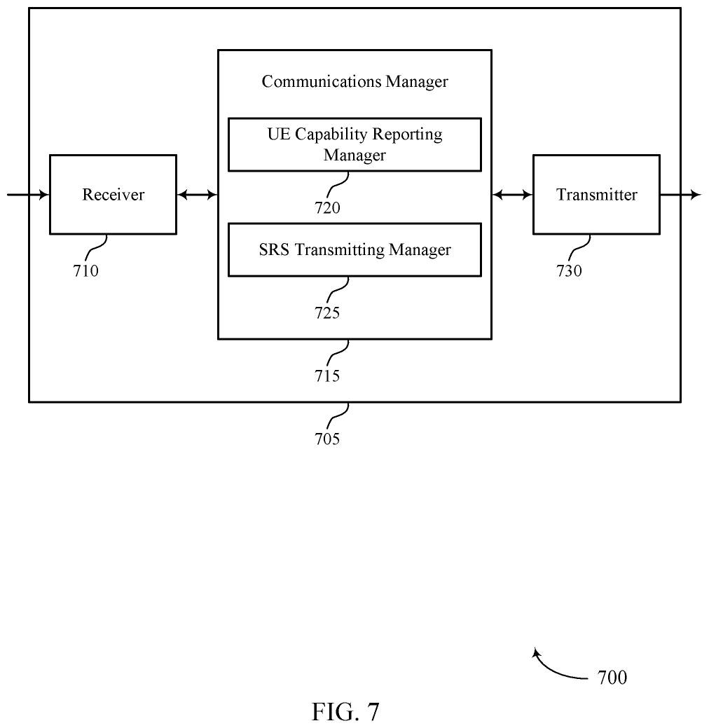

FIG. 7 shows a block diagram 700 of a device 705 that supports method to manage 5G NR SRS antenna switching concurrency in ENDC in accordance with aspects of the present disclosure. The device 705 may be an example of aspects of a device 605, or a UE 115 as described herein. The device 705 may include a receiver 710, a communications manager 715, and a transmitter 730. The device 705 may also include a processor. Each of these components may be in communication with one another (e.g., via one or more buses).

The receiver 710 may receive information such as packets, user data, or control information associated with various information channels (e.g., control channels, data channels, and information related to method to manage 5G NR SRS antenna switching concurrency in ENDC, etc.). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include an UE capability reporting manager 720 and a SRS transmitting manager 725. The communications manager 715 may be an example of aspects of the communications manager 910 described herein.

The UE capability reporting manager 720 may report a maximum SRS antenna-switching capability to a base station.

The SRS transmitting manager 725 may transmit an SRS to the base station via a reduced SRS antenna-switching capability.

The transmitter 730 may transmit signals generated by other components of the device 705. In some examples, the transmitter 730 may be collocated with a receiver 710 in a transceiver module. For example, the transmitter 730 may be an example of aspects of the transceiver 920 described with reference to FIG. 9. The transmitter 730 may utilize a single antenna or a set of antennas.

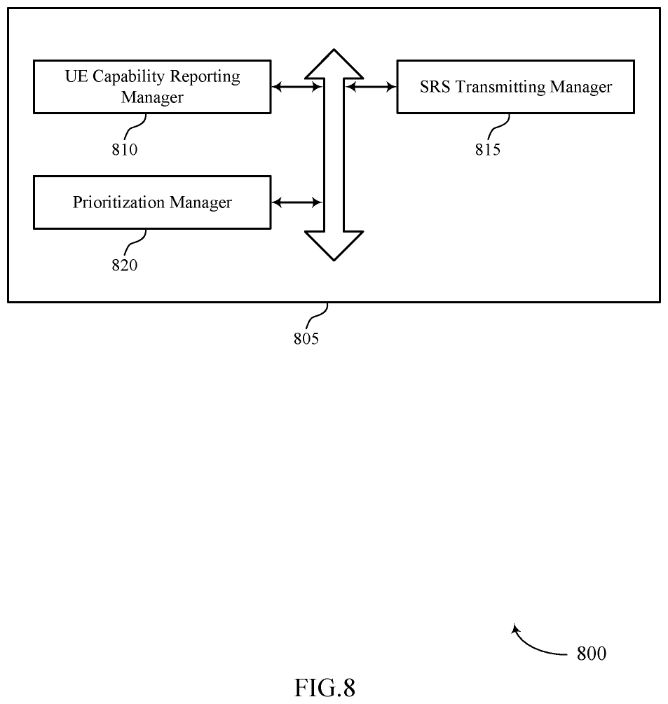

FIG. 8 shows a block diagram 800 of a communications manager 805 that supports method to manage 5G NR SRS antenna switching concurrency in ENDC in accordance with aspects of the present disclosure. The communications manager 805 may be an example of aspects of a communications manager 615, a communications manager 715, or a communications manager 910 described herein. The communications manager 805 may include an UE capability reporting manager 810, an SRS transmitting manager 815, and a prioritization manager 820. Each of these modules may communicate, directly or indirectly, with one another (e.g., via one or more buses).

The UE capability reporting manager 810 may report a maximum SRS antenna-switching capability to a base station.

The SRS transmitting manager 815 may transmit an SRS to the base station via a reduced SRS antenna-switching capability. In some examples, the SRS transmitting manager 815 may transmit the SRS via the reduced SRS antenna-switching capability when a first network connection has priority over a second network connection. In some examples, the SRS transmitting manager 815 may transmit at least one additional SRS via the maximum SRS antenna-switching capability when the second network connection has priority over the first network connection. In some examples, reducing the SRS antenna-switching capability includes masking at least one NR SRS antenna.

The prioritization manager 820 may prioritize the first network connection over the second network connection when the first network connection includes a high-priority call type, or when uplink activity of the first network connection is greater than a threshold.

In some examples, the prioritization manager 820 may prioritize the first network connection over the second network connection when a control channel downlink grant rate for the first network connection is greater than a first threshold, or when a control channel uplink grant rate for the first network connection is greater than a second threshold.

In some examples, the prioritization manager 820 may prioritize the first network connection over the second network connection when a control channel downlink grant rate for the first network connection is greater than a first threshold and a signal to noise ratio of the first network connection is less than a third threshold, or when a control channel uplink grant rate for the first network connection is greater than a second threshold and a power headroom of the first network connection is less than a fourth threshold.

In some examples, the prioritization manager 820 may prioritize the first network connection over the second network connection when a random access message one fail count for the first network connection is greater than a first threshold, when a random access message three fail count for the first network connection is greater than a second threshold, or when a scheduling request fail count for the first network connection is greater than a third threshold.

In some examples, the prioritization manager 820 may prioritize the first network connection over the second network connection based on a transmit antenna selected by a transmit antenna-switch diversity feature for the first network connection, a timing conflict between the first network connection and the second network connection, or a combination thereof.

In some examples, the prioritization manager 820 may semi-statically prioritize the first network connection over the second network connection based on the transmit antenna selected by the transmit antenna-switch diversity feature.

In some examples, the prioritization manager 820 may dynamically prioritize the first network connection over the second network connection based on the transmit antenna selected by the transmit antenna-switch diversity feature and one of a subframe timing of the first network connection or activity timing of the first network connection. The activity timing may be associated with FDD communications for the first network connection. For example, the activity timing may be based on a set of known transmit occasions for a periodic communication (e.g., VoLTE), where there are known Tx subframes for transmission. In such cases, activity timing information may be provided to an SRS controller of a UE (e.g., a start/end time of a transmission referenced to a common known timing source). Additionally or alternatively, activity timing may be based on a known on/off occasion for communications performed over the first network connection (e.g., LTE CDRS on/off periodicity which is configured for LTE CDRX mode). In such cases, periodicity and timing information (e.g., activity timing) may be provided to an SRS controller of the UE (e.g., CDRX on/off duration and periodicity for LTE communications may be referenced to a common known timing).

In some examples, prioritizing the first network connection over the second network connection when the first network connection includes critical traffic or critical control signaling. In some aspects, the terms “critical traffic” or “critical control signaling” may refer to a relative priority of traffic and control signaling, and may be based on the type of traffic/control signaling. For example, emergency calls (e.g., E911-type calls), IMS type calls (e.g., voice calls, video telephony calls) may have a higher priority over other types of calls, and may be referred to as critical traffic.

In some cases, the first network connection includes a LTE connection and the second network connection includes a 5G NR connection. In other cases, the first network connection includes a first 5G NR connection and the second network connection includes a second 5G NR connection.

FIG. 9 shows a diagram of a system 900 including a device 905 that supports method to manage 5G NR SRS antenna switching concurrency in ENDC in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may report a maximum SRS antenna-switching capability to a base station and transmit an SRS to the base station via a reduced SRS antenna-switching capability.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include random-access memory (RAM) and read-only memory (ROM). The memory 930 may store computer-readable, computer-executable code 935 including instructions that, when executed, cause the processor to perform various functions described herein. In some cases, the memory 930 may contain, among other things, a basic I/O system (BIOS) which may control basic hardware or software operation such as the interaction with peripheral components or devices.

The processor 940 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting method to manage 5g nr SRS antenna switching concurrency in ENDC).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

FIG. 10 shows a flowchart illustrating a method 1000 that supports method to manage 5G NR SRS antenna switching concurrency in ENDC in accordance with aspects of the present disclosure. The operations of method 1000 may be implemented by a UE 115 or its components as described herein. For example, the operations of method 1000 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

In some aspects, FIG. 10 is a diagram illustrating an example process 1000 performed, for example, by a UE, in accordance with various aspects of the present disclosure. The operations of the method may be implemented by a UE 215 or its components as described herein with reference to FIG. 2. In some examples, UE 215 may execute a set of codes to control the functional elements of the device to perform the functions described below. The example process 1000 is an example of adjusting a capability of NR SRS antenna-switching.

At 1005, the UE may report (e.g., advertise) a first SRS antenna-switching capability to a base station (e.g., maximum SRS antenna-switching capability). In one aspect, the UE advertises the maximum SRS antenna-switching capability via a supportedSRS-TxPortSwitch field. The operations of 1005 may be performed according to the methods described herein. In some examples, aspects of the operations of 1005 may be performed by an UE capability reporting manager as described with reference to FIGS. 6 through 9.

At 1010, the UE may transmit an SRS to the base station via a second SRS antenna-switching capability when the first network connection has priority over the second network connection, where the second SRS antenna-switching capability is is reduced with respect to the first SRS antenna-switching capability. The UE may transmit the SRS to the base station via a reduced SRS antenna-switching capability or the maximum SRS antenna switching capability. The SRS may be transmitted via the reduced SRS antenna switching capability when a first network connection has priority over a second network connection or the maximum SRS antenna switching capability when the second network connection has priority over the first network connection. The operations of 1010 may be performed according to the methods described herein. In some examples, aspects of the operations of 1010 may be performed by a SRS transmitting manager as described with reference to FIGS. 6 through 9.

In one configuration, the first network connection is prioritized over the second network connection based on prioritization criteria. The prioritization criteria may include a call type, downlink throughput, uplink throughput, message fail rate, and/or other criteria. In one configuration, the first network connection is prioritized over the second network connection based on a transmit antenna selected by a transmit antenna-switch diversity feature for the first network connection and/or a timing conflict between the first network connection and the second network connection.

As discussed for FIG. 3, the transmit antenna switch diversity feature (ASDIV) may impact the receive antenna. That is, a number of receive antenna may be interrupted (e.g., impacted) due to the SRS antenna-switching performed in response to the transmit antenna selected by the ASDIV feature and the antenna cross-switch hardware configuration. For example, a 3×3 cross-switch has a different impact on receive antenna re-mapping due to the Tx ASDIV feature in comparison to a re-mapping impact of a 4×4 cross-switch.

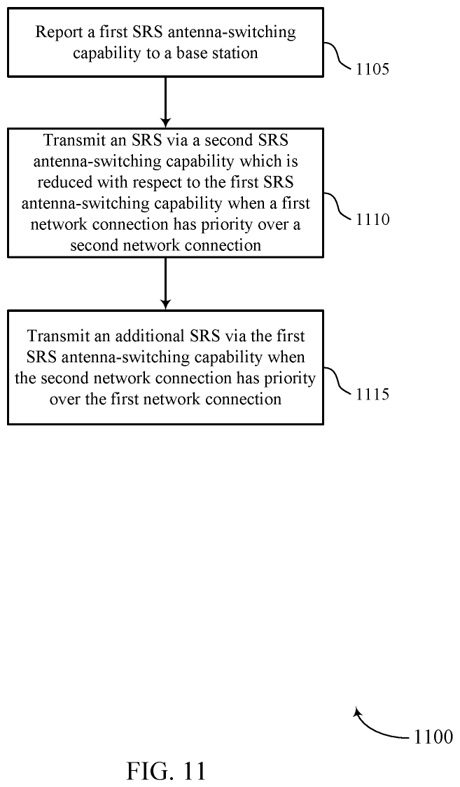

FIG. 11 shows a flowchart illustrating a method 1100 that supports method to manage 5G NR SRS antenna switching concurrency in ENDC in accordance with aspects of the present disclosure. The operations of method 1100 may be implemented by a UE 115 or its components as described herein. For example, the operations of method 1100 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1105, the UE may report a first SRS antenna-switching capability (e.g., maximum antenna-switching capability) to a base station. The operations of 1105 may be performed according to the methods described herein. In some examples, aspects of the operations of 1105 may be performed by an UE capability reporting manager as described with reference to FIGS. 6 through 9.

At 1110, the UE may transmit an SRS via a second SRS antenna-switching capability when the first network connection has priority over the second network connection, where the second SRS antenna-switching capability is reduced with respect to the first SRS antenna-switching capability. The operations of 1110 may be performed according to the methods described herein. In some examples, aspects of the operations of 1110 may be performed by a SRS transmitting manager as described with reference to FIGS. 6 through 9.

At 1115, the UE may transmit at least one additional SRS via the first SRS antenna-switching capability when the second network connection has priority over the first network connection. The operations of 1115 may be performed according to the methods described herein. In some examples, aspects of the operations of 1115 may be performed by a SRS transmitting manager as described with reference to FIGS. 6 through 9.

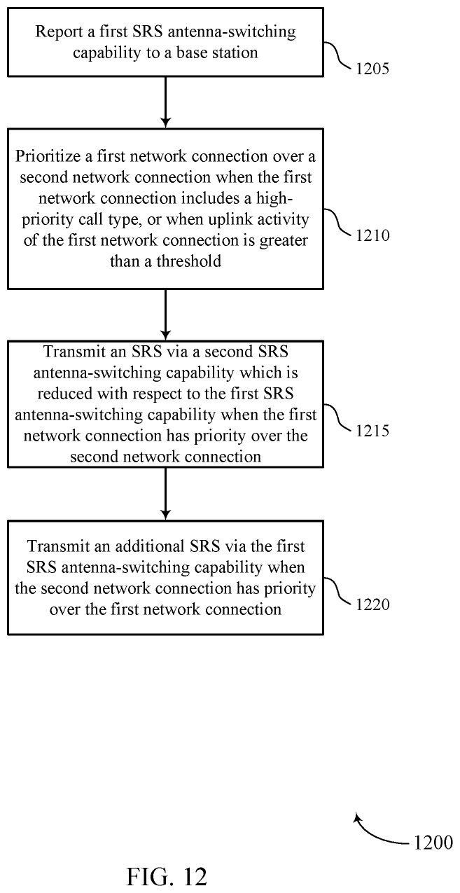

FIG. 12 shows a flowchart illustrating a method 1200 that supports method to manage 5G NR SRS antenna switching concurrency in ENDC in accordance with aspects of the present disclosure. The operations of method 1200 may be implemented by a UE 115 or its components as described herein. For example, the operations of method 1200 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1205, the UE may report a first SRS antenna-switching capability (e.g., maximum SRS antenna-switching capability) to a base station. The operations of 1205 may be performed according to the methods described herein. In some examples, aspects of the operations of 1205 may be performed by an UE capability reporting manager as described with reference to FIGS. 6 through 9.

At 1210, the UE may prioritize a first network connection over a second network connection when the first network connection includes a high-priority call type, or when uplink activity of the first network connection is greater than a threshold. The operations of 1210 may be performed according to the methods described herein. In some examples, aspects of the operations of 1210 may be performed by a prioritization manager as described with reference to FIGS. 6 through 9.

At 1215, the UE may transmit an SRS via the second SRS antenna-switching capability when the first network connection has priority over the second network connection. The operations of 1215 may be performed according to the methods described herein. In some examples, aspects of the operations of 1215 may be performed by a SRS transmitting manager as described with reference to FIGS. 6 through 9.

At 1220, the UE may transmit at least one additional SRS via the first SRS antenna-switching capability when the second network connection has priority over the first network connection. The operations of 1220 may be performed according to the methods described herein. In some examples, aspects of the operations of 1220 may be performed by a SRS transmitting manager as described with reference to FIGS. 6 through 9.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method of wireless communication at a UE having one or more antennas shared between a first network connection and a second network connection in a dual connectivity mode, comprising: reporting a first SRS antenna-switching capability to a base station; and transmitting an SRS to the base station via a second SRS antenna-switching capability when the first network connection has priority over the second network connection, wherein the second SRS antenna-switching capability is reduced with respect to the first SRS antenna-switching capability.

Aspect 2: The method of aspect 1, further comprising: transmitting the SRS via the first SRS antenna-switching capability when the second network connection has priority over the first network connection.

Aspect 3: The method of any of aspects 1 through 2, further comprising: prioritizing the first network connection over the second network connection when the first network connection comprises a high-priority call type, or when uplink activity of the first network connection is greater than a threshold.

Aspect 4: The method of aspect 3, wherein the high-priority call type comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

Aspect 5: The method of any of aspects 1 through 4, further comprising: prioritizing the first network connection over the second network connection when a control channel downlink grant rate of the first network connection is greater than a first threshold, or when a control channel uplink grant rate of the first network connection is greater than a second threshold.

Aspect 6: The method of any of aspects 1 through 5, further comprising: prioritizing the first network connection over the second network connection when a control channel downlink grant rate of the first network connection is greater than a first threshold and a signal to noise ratio (SNR) of the first network connection is less than a third threshold, or when a control channel uplink grant rate of the first network connection is greater than a second threshold and a power headroom (PHR) of the first network connection is less than a fourth threshold.

Aspect 7: The method of any of aspects 1 through 6, further comprising: prioritizing the first network connection over the second network connection when a random access message one fail count of the first network connection is greater than a first threshold, when a random access message three fail count of the first network connection is greater than a second threshold, or when a scheduling request fail count of the first network connection is greater than a third threshold.

Aspect 8: The method of any of aspects 1 through 7, further comprising: prioritizing the first network connection over the second network connection based at least in part on a timing conflict between a first set of transmit occasions associated with a first call performed over the first network connection and a second set of transmit occasions associated with a second call performed over the second network connection.

Aspect 9: The method of aspect 8, wherein the first call, the second call, or both, comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

Aspect 10: The method of any of aspects 1 through 9, further comprising: prioritizing the first network connection over the second network connection based at least in part on a first discontinuous reception procedure associated with the first network connection and a second discontinuous reception procedure associated with the second network connection.

Aspect 11: The method of aspect 10, further comprising: prioritizing the first network connection over the second network connection based at least in part on a timing conflict between a first on duration of the first discontinuous reception procedure and a second on duration of the second discontinuous reception procedure.

Aspect 12: The method of any of aspects 1 through 11, further comprising: prioritizing the first network connection over the second network connection based on a transmit antenna selected by a transmit antenna-switch diversity feature for the first network connection, a timing conflict between the first network connection and the second network connection, or a combination thereof.

Aspect 13: The method of aspect 12, further comprising: semi-statically prioritizing the first network connection over the second network connection based on the transmit antenna selected by the transmit antenna-switch diversity feature.

Aspect 14: The method of any of aspects 12 through 13, further comprising: dynamically prioritizing the first network connection over the second network connection based on the transmit antenna selected by the transmit antenna-switch diversity feature and one of a subframe timing of the first network connection or activity timing of the first network connection.

Aspect 15: The method of any of aspects 1 through 14, further comprising: prioritizing the first network connection over the second network connection when the first network connection comprises critical traffic or critical control signaling.

Aspect 16: The method of any of aspects 1 through 15, wherein the first network connection comprises a long term evolution (LTE) connection and the second network connection comprises a fifth generation (5G) new radio (NR) connection, or the first network connection comprises a first 5G NR connection and the second network connection comprises a second 5G NR connection.

Aspect 17: The method of any of aspects 1 through 16, wherein the second SRS antenna-switching capability is reduced with respect to the first SRS antenna-switching capability by masking at least one new radio (NR) SRS antenna.

Aspect 18: An apparatus comprising a processor; memory coupled with the processor; and instructions stored in the memory and executable by the processor to cause the apparatus to perform a method of any of aspects 1 through 17.

Aspect 19: An apparatus comprising at least one means for performing a method of any of aspects 1 through 17.

Aspect 20: A non-transitory computer-readable medium storing code the code comprising instructions executable by a processor to perform a method of any of aspects 1 through 17.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of wireless communication at a user equipment (UE) having one or more antennas shared between a first network connection and a second network connection in a dual connectivity mode, comprising:
reporting a first sounding reference signal (SRS) antenna-switching capability to a base station; and
transmitting an SRS to the base station via a second SRS antenna-switching capability when the first network connection has priority over the second network connection, wherein the second SRS antenna-switching capability is reduced with respect to the first SRS antenna-switching capability.

2. The method of claim 1, further comprising:
transmitting the SRS via the first SRS antenna-switching capability when the second network connection has priority over the first network connection.

3. The method of claim 1, further comprising:
prioritizing the first network connection over the second network connection when the first network connection comprises a high-priority call type, or when uplink activity of the first network connection is greater than a threshold.

4. The method of claim 3, wherein the high-priority call type comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

5. The method of claim 1, further comprising:
prioritizing the first network connection over the second network connection when a control channel downlink grant rate of the first network connection is greater than a first threshold, or when a control channel uplink grant rate of the first network connection is greater than a second threshold.

6. The method of claim 1, further comprising:
prioritizing the first network connection over the second network connection when a control channel downlink grant rate of the first network connection is greater than a first threshold and a signal to noise ratio (SNR) of the first network connection is less than a third threshold, or when a control channel uplink grant rate of the first network connection is greater than a second threshold and a power headroom (PHR) of the first network connection is less than a fourth threshold.

7. The method of claim 1, further comprising:
prioritizing the first network connection over the second network connection when a random access message one fail count of the first network connection is greater than a first threshold, when a random access message three fail count of the first network connection is greater than a second threshold, or when a scheduling request fail count of the first network connection is greater than a third threshold.

8. The method of claim 1, further comprising:
prioritizing the first network connection over the second network connection based at least in part on a timing conflict between a first set of transmit occasions associated with a first call performed over the first network connection and a second set of transmit occasions associated with a second call performed over the second network connection.

9. The method of claim 8, wherein the first call, the second call, or both, comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

10. The method of claim 1, further comprising:
prioritizing the first network connection over the second network connection based at least in part on a first discontinuous reception procedure associated with the first network connection and a second discontinuous reception procedure associated with the second network connection.

11. The method of claim 10, further comprising:
prioritizing the first network connection over the second network connection based at least in part on a timing conflict between a first on duration of the first discontinuous reception procedure and a second on duration of the second discontinuous reception procedure.

12. The method of claim 1, further comprising:
prioritizing the first network connection over the second network connection based on a transmit antenna selected by a transmit antenna-switch diversity feature for the first network connection, a timing conflict between the first network connection and the second network connection, or a combination thereof.

13. The method of claim 12, further comprising:
semi-statically prioritizing the first network connection over the second network connection based on the transmit antenna selected by the transmit antenna-switch diversity feature.

14. The method of claim 12, further comprising:
dynamically prioritizing the first network connection over the second network connection based on the transmit antenna selected by the transmit antenna-switch diversity feature and one of a subframe timing of the first network connection or activity timing of the first network connection.

15. The method of claim 1, further comprising:
prioritizing the first network connection over the second network connection when the first network connection comprises critical traffic or critical control signaling.

16. The method of claim 1, wherein the first network connection comprises a long term evolution (LTE) connection and the second network connection comprises a fifth generation (5G) new radio (NR) connection, or wherein the first network connection comprises a first 5G NR connection and the second network connection comprises a second 5G NR connection.

17. The method of claim 1, wherein the second SRS antenna-switching capability is reduced with respect to the first SRS antenna-switching capability by masking at least one new radio (NR) SRS antenna.

18. An apparatus for wireless communication at a user equipment (UE) having one or more antennas shared between a first network connection and a second network connection in a dual connectivity mode, comprising:
means for reporting a first sounding reference signal (SRS) antenna-switching capability to a base station; and
means for transmitting an SRS to the base station via a second SRS antenna-switching capability when the first network connection has priority over the second network connection, wherein the second SRS antenna switching capability is reduced with respect to the first SRS antenna-switching capability.

19. The apparatus of claim 18, further comprising:
means for transmitting the SRS via the first SRS antenna-switching capability when the second network connection has priority over the first network connection.

20. The apparatus of claim 18, further comprising:
means for prioritizing the first network connection over the second network connection when the first network connection comprises a high-priority call type, or when uplink activity of the first network connection is greater than a threshold.

21. The apparatus of claim 20, wherein the high-priority call type comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

22. The apparatus of claim 18, further comprising:
means for prioritizing the first network connection over the second network connection when a control channel downlink grant rate of the first network connection is greater than a first threshold, or when a control channel uplink grant rate of the first network connection is greater than a second threshold.

23. The apparatus of claim 18, further comprising:
means for prioritizing the first network connection over the second network connection when a control channel downlink grant rate of the first network connection is greater than a first threshold and a signal to noise ratio of the first network connection is less than a third threshold, or when a control channel uplink grant rate of the first network connection is greater than a second threshold and a power headroom of the first network connection is less than a fourth threshold.

24. The apparatus of claim 18, further comprising:
means for prioritizing the first network connection over the second network connection when a random access message one fail count of the first network connection is greater than a first threshold, when a random access message three fail count of the first network connection is greater than a second threshold, or when a scheduling request fail count of the first network connection is greater than a third threshold.

25. The apparatus of claim 18, further comprising:
prioritizing the first network connection over the second network connection based at least in part on a timing conflict between a first set of transmit occasions associated with a first call performed over the first network connection and a second set of transmit occasions associated with a second call performed over the second network connection.

26. The apparatus of claim 25, wherein the first call, the second call, or both, comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

27. The apparatus of claim 18, further comprising:
prioritizing the first network connection over the second network connection based at least in part on a first discontinuous reception procedure associated with the first network connection and a second discontinuous reception procedure associated with the second network connection.

28. The apparatus of claim 27, further comprising:
prioritizing the first network connection over the second network connection based at least in part on a timing conflict between a first on duration of the first discontinuous reception procedure and a second on duration of the second discontinuous reception procedure.

29. The apparatus of claim 18, further comprising:
means for prioritizing the first network connection over the second network connection based on a transmit antenna selected by a transmit antenna-switch diversity feature for the first network connection, a timing conflict between the first network connection and the second network connection, or a combination thereof.

30. The apparatus of claim 29, further comprising:
means for semi-statically prioritizing the first network connection over the second network connection based on the transmit antenna selected by the transmit antenna-switch diversity feature.

31. The apparatus of claim 29, further comprising:
means for dynamically prioritizing the first network connection over the second network connection based on the transmit antenna selected by the transmit antenna-switch diversity feature and one of a subframe timing of the first network connection or activity timing of the first network connection.

32. The apparatus of claim 18, further comprising:
means for prioritizing the first network connection over the second network connection when the first network connection comprises critical traffic or critical control signaling.

33. The apparatus of claim 18, wherein the first network connection comprises a long term evolution (LTE) connection and the second network connection comprises a fifth generation (5G) New Radio (NR) connection, or wherein the first network connection comprises a first 5G NR connection and the second network connection comprises a second 5G NR connection.

34. The apparatus of claim 18, wherein the second SRS antenna-switching capability is reduced with respect to the first SRS antenna-switching capability by masking at least one New Radio (NR) SRS antenna.

35. An apparatus for wireless communication at a user equipment (UE) having one or more antennas shared between a first network connection and a second network connection in a dual connectivity mode, comprising:
a memory; and
at least one processor coupled to the memory, the at least one processor configured to:
report a first sounding reference signal (SRS) antenna-switching capability to a base station; and
transmit an SRS to the base station via a second SRS antenna-switching capability when the first network connection has priority over the second network connection, wherein the second SRS antenna-switching capability is reduced with respect to the first SRS antenna-switching capability.

36. The apparatus of claim 35, wherein the at least one processor is further configured to:
transmit the SRS via the first SRS antenna-switching capability when the second network connection has priority over the first network connection.

37. The apparatus of claim 35, wherein the at least one processor is further configured to:
prioritize the first network connection over the second network connection when the first network connection comprises a high-priority call type, or when an uplink activity of the first network connection is greater than a threshold.

38. The apparatus of claim 37, wherein the high-priority call type comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

39. The apparatus of claim 35, wherein the at least one processor is further configured to:
prioritize the first network connection over the second network connection when a control channel downlink grant rate is greater than a first threshold, or when a control channel uplink grant rate is greater than a second threshold.

40. The apparatus of claim 35, wherein the at least one processor is further configured to:
prioritize the first network connection over the second network connection when a control channel downlink grant rate of the first network connection is greater than a first threshold and a signal to noise ratio of the first network connection is less than a third threshold, or when a control channel uplink grant rate of the first network connection is greater than a second threshold and a power headroom of the first network connection is less than a fourth threshold.

41. The apparatus of claim 35, wherein the at least one processor is further configured to:
prioritize the first network connection over the second network connection when a random access message one fail count of the first network connection is greater than a first threshold, when a random access message three fail count of the first network connection is greater than a second threshold, or when a scheduling request fail count of the first network connection is greater than a third threshold.

42. The apparatus of claim 35, further comprising:
prioritizing the first network connection over the second network connection based at least in part on a timing conflict between a first set of transmit occasions associated with a first call performed over the first network connection and a second set of transmit occasions associated with a second call performed over the second network connection.

43. The apparatus of claim 42, wherein the first call, the second call, or both, comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

44. The apparatus of claim 35, further comprising:
prioritizing the first network connection over the second network connection based at least in part on a first discontinuous reception procedure associated with the first network connection and a second discontinuous reception procedure associated with the second network connection.

45. The apparatus of claim 44, further comprising:
prioritizing the first network connection over the second network connection based at least in part on a timing conflict between a first on duration of the first discontinuous reception procedure and a second on duration of the second discontinuous reception procedure.

46. The apparatus of claim 35, wherein the at least one processor is further configured to:
prioritize the first network connection over the second network connection based on a transmit antenna selected by a transmit antenna-switch diversity feature for the first network connection, a timing conflict between the first network connection and the second network connection, or a combination thereof.

47. The apparatus of claim 46, wherein the at least one processor is further configured to:
semi-statically prioritize the first network connection over the second network connection based on the transmit antenna selected by the transmit antenna-switch diversity feature.

48. The apparatus of claim 46, wherein the at least one processor is further configured to:
dynamically prioritize the first network connection over the second network connection based on the transmit antenna selected by the transmit antenna-switch diversity feature and one of a subframe timing of the first network connection or activity timing of the first network connection.

49. The apparatus of claim 35, wherein the at least one processor is further configured to:
prioritize the first network connection over the second network connection when the first network connection comprises critical traffic or critical control signaling.

50. The apparatus of claim 35, wherein the first network connection comprises a long term evolution (LTE) connection and the second network connection comprises a fifth generation (5G) New Radio (NR) connection, or wherein the first network connection comprises a first 5G NR connection and the second network connection comprises a second 5G NR connection.

51. The apparatus of claim 35, wherein the second SRS antenna-switching capability is reduced with respect to the first SRS antenna-switching capability by masking at least one New Radio (NR) SRS antenna.

52. A non-transitory computer-readable medium having program code recorded thereon for wireless communication at a user equipment (UE) having one or more antennas shared between a first network connection and a second network connection in a dual connectivity mode, the program code executed by a processor and comprising:
program code to report a first sounding reference signal (SRS) antenna-switching capability to a base station; and
program code to transmit an SRS to the base station via a second SRS antenna-switching capability when the first network connection has priority over the second network connection, wherein the second SRS antenna-switching capability is reduced with respect to the first SRS antenna-switching capability.

53. The non-transitory computer-readable medium of claim 52, further comprising:
program code to transmit the SRS via the first SRS antenna-switching capability when the second network connection has priority over the first network connection.

54. The non-transitory computer-readable medium of claim 52, further comprising:
program code to prioritize the first network connection over the second network connection when the first network connection comprises a high-priority call type, or when uplink activity of the first network connection is greater than a threshold.

55. The non-transitory computer-readable medium of claim 54, wherein the high-priority call type comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

56. The non-transitory computer-readable medium of claim 52, further comprising:
program code to prioritize the first network connection over the second network connection when a control channel downlink grant rate of the first network connection is greater than a first threshold; or when a control channel uplink grant rate of the first network connection is greater than a second threshold.

57. The non-transitory computer-readable medium of claim 52, further comprising:
program code to prioritize the first network connection over the second network connection when a control channel downlink grant rate of the first network connection is greater than a first threshold and a signal to noise ratio of the first network connection is less than a third threshold, or when a control channel uplink grant rate of the first network connection is greater than a second threshold and a power headroom of the first network connection is less than a fourth threshold.

58. The non-transitory computer-readable medium of claim 52, further comprising:
program code to prioritize the first network connection over the second network connection when a random access message one fail count of the first network connection is greater than a first threshold, when a random access message three fail count of the first network connection is greater than a second threshold, or when a scheduling request fail count of the first network connection is greater than a third threshold.

59. The non-transitory computer-readable medium of claim 52, further comprising:
prioritizing the first network connection over the second network connection based at least in part on a timing conflict between a first set of transmit occasions associated with a first call performed over the first network connection and a second set of transmit occasions associated with a second call performed over the second network connection.

60. The non-transitory computer-readable medium of claim 59, wherein the first call, the second call, or both, comprises an E-911 call, an internet protocol (IP) multimedia-system (IMS) call, a voice over internet protocol (VoIP) call, a voice over long-term evolution (VoLTE) call, a voice over 5G NR (VoNR) call, a video telephony call, or any combination thereof.

61. The non-transitory computer-readable medium of claim 52, further comprising:
prioritizing the first network connection over the second network connection based at least in part on a first discontinuous reception procedure associated with the first network connection and a second discontinuous reception procedure associated with the second network connection.

62. The non-transitory computer-readable medium of claim 61, further comprising:
prioritizing the first network connection over the second network connection based at least in part on a timing conflict between a first on duration of the first discontinuous reception procedure and a second on duration of the second discontinuous reception procedure.

63. The non-transitory computer-readable medium of claim 52, further comprising:
program code to prioritize the first network connection over the second network connection based on a transmit antenna selected by a transmit antenna-switch diversity feature for the first network connection, a timing conflict between the first network connection and the second network connection, or a combination thereof.

64. The non-transitory computer-readable medium of claim 63, further comprising:
program code to semi-statically prioritize the first network connection over the second network connection based on the transmit antenna selected by the transmit antenna-switch diversity feature.

65. The non-transitory computer-readable medium of claim 63, further comprising:
program code to dynamically prioritize the first network connection over the second network connection based on the transmit antenna selected by the transmit antenna-switch diversity feature and one of a subframe timing of the first network connection or activity timing of the first network connection.

66. The non-transitory computer-readable medium of claim 52, further comprising:
program code to prioritize the first network connection over the second network connection when the first network connection comprises critical traffic or critical control signaling.

67. The non-transitory computer-readable medium of claim 52, wherein the first network connection comprises a long term evolution (LTE) connection and the second network connection comprises a fifth generation (5G) New Radio (NR) connection, or wherein the first network connection comprises a first 5G NR connection and the second network connection comprises a second 5G NR connection.

68. The non-transitory computer-readable medium of claim 52, wherein the second SRS antenna-switching capability is reduced with respect to the first SRS antenna-switching capability by masking at least one New Radio (NR) SRS antenna.
